(19) United States
(12) Patent Application Publication
(10) Pub. No.: US 2022/0263650 A1
(43) Pub. Date: Aug. 18, 2022

(54) METHOD FOR ESTABLISHING A SECURE DATA COMMUNICATION FOR A PROCESSING DEVICE AND A TRUST MODULE FOR GENERATING A CRYPTOGRAPHIC KEY AND A FIELD DEVICE

(71) Applicant: SIEMENS AKTIENGESELLSCHAFT, München (DE)

(72) Inventor: Rainer Falk, Poing (DE)

(21) Appl. No.: 17/618,880

(22) PCT Filed: Apr. 23, 2020
(86) PCT No.: PCT/EP2020/061402

§ 371 Date: Dec. 13, 2021

(30) Foreign Application Priority Data
Jun. 14, 2019 (EP) 19180141.4

(51) Int. Cl. H04L 9/08; H04L 9/32

(52) U.S. Cl. CPC H04L 9/0825; H04L 9/0877; H04L 2209/127; H04L 9/0869; H04L 9/3247

(57) ABSTRACT

A method for establishing a secure data communication based on a cryptographic key is provided. The method includes submitting a cryptographic key request to a trust module. A digital signature is verified based on a public key assigned to the processing device. An internal cryptographic key is generated based on the public key assigned to the processing device and a secret key assigned to the trust module. The cryptographic key is generated based on the internal cryptographic key and a key identifier of the processing device. The cryptographic key is encrypted using the public key assigned to the processing device. The encrypted cryptographic key is transmitted to the processing device. The trust module is implemented as a stateless Lambda trust anchor.

This application is the National Stage of International Application No. PCT/EP2020/061402, filed Apr. 23, 2020, which claims the benefit of European Patent Application No. EP 19180141.4, filed Jun. 14, 2019. The entire contents of these document are hereby incorporated herein by reference.

### BACKGROUND

This disclosure relates to a method and a computer program product for establishing a secure data communication for a processing device. Further, a trust module for generating a cryptographic key and a field device are provided.

Secure elements (or trust modules) are used for secured storing of cryptographic keys and for executing cryptographic operations in a secured execution environment. Conventionally, a trust module may be implemented as a separated hardware component such as a crypto controller or a hardware security module, or may be integrated on a field programmable gate array (FPGA) or within a separated execution environment such as a Trusted Execution Environment (TEE).

The main requirement of the above-described types of trust modules is to protect or to secure the access to the trust module in order to avoid that, for example, an unauthorized application of a processing device (or an entity) may obtain cryptographic keys or is able to manipulate the trust module.

If the user or the processing device wants to get access to the trust module, the processing device is to perform an access authentication. Traditionally, the access authentication is executed (e.g., using a password, a PIN, a biometric ID, etc.). In case of a successful access authentication, the trust module authenticates the processing device and allows access to the cryptographic keys and operations of the trust module.

However, the above-described types of access authentication require an explicit implementation of the of the access authentication function and a configuration of the respective secure element.

### SUMMARY AND DESCRIPTION

The scope of the present invention is defined solely by the appended claims and is not affected to any degree by the statements within this summary.

The present embodiments may obviate one or more of the drawbacks or limitations in the related art. For example, an access authentication to a trust module is simplified.

According to a first aspect, a method for establishing a secure data communication for a processing device based on a cryptographic key is provided. The method includes submitting a cryptographic key request to a trust module. The cryptographic key request includes a key identifier provided by the processing device. The key request is protected by a digital signature of the processing device. The method also includes verifying, at the trust module, the digital signature based on a public key assigned to the processing device. The method also includes generating, at the trust module, an internal cryptographic key based on the public key assigned to the processing device and a secret key assigned to the trust module. The method also includes generating, at the trust module, the cryptographic key based on the internal cryptographic key and the key identifier provided by the processing device. The method also includes encrypting, at the trust module, the cryptographic key using the public key assigned to the processing device, and transmitting the encrypted cryptographic key to the processing device. The trust module is implemented as a stateless Lambda trust anchor.

With the above-described method, for example, by using the stateless Lambda trust anchor, it is possible that any processing device or entity may get access to the trust module and may receive from the trust module, for example, a requested cryptographic key that is unique for the single processing device or entity. By using the requested cryptographic key, the processing device or entity is able to establish a secure data communication between the processing device or entity and another device or entity.

This is possible because the employed trust module is a “stateless” device or module. One may speak of a stateless a Lambda trust anchor or an implemented Lambda trust anchor function.

The key identifier allows the processing device to request multiple keys for different purposes. The key identifier may encode the purpose as intended by the processing device. However, a processing device may use arbitrary key identifiers that do not have to be known in advance by the trust module.

In one embodiment, the processing device may decrypt the encrypted cryptographic key using a secret key or private key. The decrypted key may be used, for example, to authenticate the processing device or to decrypt encrypted configuration data.

In one embodiment, it is possible to flexibly activate the trust module function in an embedded system or an edge device in a cloud computing environment. The trust anchor is, for example, realized as an instance within the trust module on demand (e.g., in a cloud backend) only if an access to the trust module or, for example, a cryptographic key is needed. Further, the trust module is not device-specific or Application-specific, and it is not personalized. Thus, by implementing the trust module, a depersonalized, universal hardware-based key storage and generation in devices may be implemented. Therefore, the trust module may be subsequently integrated in existing devices. This increases the usability and the availability of the trust module.

Further, any arbitrary processing device or entity may get access to the trust module or may use the trust module because as a stateless trust module; no specific access authentication configuration for a processing device or entity that wants to get access to the trust module or a configuration of keys and key identifiers is required. In one embodiment, this increases the flexibility of the trust module while the access authentication configuration effort is decreased or removed.

The trust module may be implemented as a hardware application such as a partial bitstream for a partial reconfiguration of a field programmable gate array (FPGA). Then, the trust anchor is retrofittable and updateable.

If multiple processing devices or entities request access to the trust module, for each processing device or entity, a different internal cryptographic key and thus a different cryptographic key is generated and processed by the trust module. Thus, for example, a first processing device that got a first cryptographic key cannot use a second cryptographic key of a second processing device because the second cryptographic key is only assigned to the second processing device due to the public key of the second processing device. Therefore, the data security is improved.

Also, as long as the processing devices or entities securely store their own private keys (e.g., secret keys), no attacker may obtain and decrypt the cryptographic key that is generated by the trust module. This increases the data security as well.

The trust module is implemented as a stateless trust module or a stateless lambda trust anchor or a stateless lambda trust anchor function. Further, for example, the trust module is implemented to perform several cryptographic operations. Cryptographic operations may include encrypting, decrypting, signature calculation, signature verification, Message authentication code (MAC) calculation, MAC verification, key generation, loading of a key. If the trust module is implemented as a separate hardware component, a processing device or entity may get access to a physical interface of the trust module. If the trust module is integrated on the FPGA or within a separate execution environment, the processing device or entity may get access to an internal software interface of the trust module. In one embodiment, the trust module does not contain information about a specific processing device, application, or entity that is allowed to get access to the trust module or allowed to get a key.

A processing device may be a central processing unit (CPU), a processor, or a processing unit configured to perform computational operations such as calculating values or executing programs or applications. For example, the processing device includes at least an application and an operating system. The operating system may be implemented as an operating software. The application or application software may include computer programs that are used to process or implement a useful or desired non-operating-system functionality. The processing device may be a caller who wants to get access to the trust module. A processing unit or an entity may include a plurality of applications. In one embodiment, the trust module as a programmable hardware unit such as a field programmable gate array (FPGA) may be used by a plurality of applications.

For example, the application generates the cryptographic key request, which is then submitted to the trust module. In one embodiment, the cryptographic key request is a request for obtaining a derived cryptographic key from the trust module based on the identifier or key identifier. In one embodiment, the key identifier provided by the processing device is a key derivation parameter that is specific for the intended purpose of the requested key (e.g., for device authentication or for decryption of configuration data). Specifically, the key identifier and the digital signature are submitted from the processing device to the trust module. In one embodiment, the key identifier is a key purpose identifier or a key category identifier. In one embodiment, the key identifier may be a derivation parameter (e.g., a sequence of bits or a text string that designates the purpose of the requested key). For example, the key identifier may be “configData” or “deviceAuthentication”.

In one embodiment, an entity is a processing unit, an application, a software application, a container, a container on a field device that has the ability for executing applications, an Internet-of-Things-gateway (IoT gateway), an IoT-backend, a client, a server, or a user that wants to get access to the trust module by using a processing device.

In the verifying act, the format of the digital signature (e.g., the cryptographic part of the digital signature) is verified as to whether the digital signature includes correct cryptographic parameters. Specifically, the digital signature includes correct cryptographic parameters if the digital signature is verifiable with the public key assigned to a processing device. The private key or secret key may be provided to the trust module as part of the key request. For example, the private key or secret key may be part of the digital signature structure. In another variant, the private key may be provided as part of the setup of the communication channel between the processing device and the trust module.

Generating an internal cryptographic key is at least based on the public key of the processing device. Generating the internal cryptographic key is at least based on the public key used to verify the digital signature of the caller.

In one embodiment, the internal cryptographic key is a symmetrical cryptographic key.

Specifically, at the trust module, the internal cryptographic key is generated based on additional parameters. For example, the internal cryptographic key may be generated based on a device identifier of the trust module.

For example, the secret key assigned to the trust module is a symmetrical cryptographic key.

Specifically, the generated cryptographic key is formed as a symmetrical cryptographic key. The cryptographic key may be further used for encrypting, decrypting, digital signing, or other cryptographic operations that may be performed by the processing device or the entity to which the cryptographic key is assigned.

In one embodiment, the encrypted cryptographic key may include a cryptographic checksum (e.g., authenticated encryption).

According to an embodiment, the method further includes at least one of the acts: decrypting, at the processing device, the encrypted cryptographic key using a secret key assigned to the processing device; and establishing a secure data communication between the processing device and another device using the cryptographic key.

In one embodiment, the trust module provides at least the cryptographic key to the processing device. The processing device uses this cryptographic key to establish a secured data communication between the processing device and another device. Thus, by using the obtained generated cryptographic key, a reliably and secured data transmission between the processing device and any other device for transmitting data may be implemented.

For example, the secure data communication is implemented as a protected data communication or a protected data communication channel, where the protection is achieved by using the cryptographic key.

Specifically, another device is a field device implemented in an automation system environment, such as a programmable logic controller, an IoT device, an edge device, or an edge cloud device. The other device may be also a fixed or removable configuration module storing configuration data.

According to a further embodiment, the public key assigned to the processing device is submitted to the trust module as a part of the digital signature or as a raw key or by referencing the public key.

In one embodiment, by submitting the public key as a part of the digital signature, the data security is increased because the digital signature may include unique identification information assigned to the owner of the public key; thus, a more reliable assignment to the owner of the public key is implemented.

In one embodiment, a raw key is a public key according to an X.509 certificate without other data or information that is implemented in the X.509 certificate.

According to a further embodiment, the method further includes generating the internal cryptographic key using a first key derivation function, where the first key derivation function maps the public key assigned to the processing device and maps the secret key assigned to the trust module to the internal cryptographic key.

In one embodiment, the first key derivation function is used in conjunction with non-secret parameters such as the public key assigned to the processing device to derive at least one key from a secret key assigned to the trust module. In one embodiment, using a key derivation function (e.g., first or second key derivation function) may prevent that an attacker, which receives the derived key such as the cryptographic key, obtains useful information about the original keys that are used as an input for the key derivation function. This increases the security of the cryptographical system. Further, specifically, compared to a digital signature, a key derivation function has a decreased computing time and requires shorter cryptographic keys.

Specifically, the generated internal cryptographic key is a symmetrical cryptographic key.

For example, a key derivation function such as the first key derivation or second key derivation function is a cryptographic operation that generates, by using at least one cryptographic key, one or a plurality of cryptographic keys.

In one embodiment, the first key derivation function as well as the second key derivation function are implemented as symmetrical key derivation functions, respectively. For example, symmetrical key derivation functions include a key derivation function (KDF), HKDF, and HMAC-SHA256 (HMAC-Secure Hash Algorithm 2). For example, HKDF is a simple KDF based on a hash-based message authentication code (HMAC).

According to a further embodiment, the method further includes generating, the internal cryptographic key using a key generation function at which a public-private key pair is generated based on a primary seed.

In one embodiment, by using a primary seed (e.g., by using a key generation function that uses for key generation a primary seed), it is possible to generate the internal cryptographic key “on the fly”. For example, “on the fly” may be that the internal cryptographic key is generated at the request and is stored in a volatile storage unit. This has the advantage that the generated internal cryptographic key requires no persistent memory space or storage space and may be deleted after the processing of the request is finished.

In this embodiment, in contrast to a key derivation function, a key generation function is used. For example, a public-private key pair includes a public key and a private key or secret key. The public key may be used for encrypting, and the private key may be used for decrypting.

A primary seed, a primary seed value, or a seed value is used as a parameter for generating the public-private key pair. Specifically, if the trust module is a trusted platform module (TPM), the TPM is configured to generate, by using a primary seed value, an asymmetrical public-private key pair for different cryptographic algorithms such as Rivest Shamir and Adleman (RSA), Digital signature algorithm (DSA) or Elliptic curve digital signature algorithm (ECDSA).

In one embodiment, if a single processing device executes a plurality of cryptographic key requests, at every cryptographic key request, the same internal cryptographic key is generated because the key generation function is a deterministic function.

According to a further embodiment, the method further includes generating the cryptographic key using a second key derivation function, where the second key derivation function maps the internal cryptographic key and the key identifier of the processing device to the cryptographic key.

In one embodiment, the cryptographic key is formed as a symmetrical cryptographic key that is derived or generated using the second derivation function.

Further, the advantages of the first key derivation function also applies to the second derivation function.

According to a further embodiment, the method further includes decrypting, employing the secret key that is assigned to the trust module, a data structure that is transmitted as a part of the cryptographic key request from the processing device to the trust module in order to obtain a decrypted key out of the data structure. The decrypted key is used for a cryptographic operation of the trust module.

In one embodiment, the data structure includes at least a “Black Key Blob”. For example, the trust module uses its private key or secret key to decrypt the transmitted “Black Key Blob”. As a result of the decrypted “Black Key Blob”, a decrypted key, which is contained in the “Black Key Blob”, is used for cryptographic operations of the trust module. Specifically, a cryptographic operation is an operation that is executed whole or as parts from the trust module and includes encrypting, decrypting, signature calculation, or signature verification.

In one embodiment, the “Black Key Blob” may be stored external to the trust module (e.g., in a flash memory of the processing unit). Further, at a request to the trust module from the processing device, the “Black Key Blob” may be provided to the trust module.

According to a further embodiment, the method further includes submitting the cryptographic key request from the processing device to the trust module via an authenticated communication channel.

In one embodiment, by submitting the cryptographic key request from the processing device to the trust module via an authenticated communication channel, the data security is increased.

In one embodiment, the authenticated communication channel is formed by using a Transport layer security (TLS) protocol, an Internet protocol security (IPsec), or an Internet key exchange (IKEv2) protocol.

According to a further embodiment, the method further includes storing the generated internal cryptographic key in a volatile storage unit.

In one embodiment, the internal cryptographic key is generated “on the fly”. For example, “on the fly” may be that the internal cryptographic key is generated at the request and is stored in a volatile storage unit. This has the advantage that the generated internal cryptographic key requires no persistent memory space or storage space and may be deleted after the processing of the request is finished. Thus, in this embodiment, no generated internal cryptographic key is persistently stored. Thus, the trust module may be implemented in existing devices because no non-volatile storage unit for storing generated cryptographic keys is required.

In one embodiment, a volatile storage unit is a storage unit that stores its data as long as the storage unit is supplied with power or supply voltage. Examples for a volatile storage unit are Random access memories (RAM), Dynamic random access memories (DRAM), or Static random access memories (SRAM).

According to a further embodiment, the method further includes storing the generated internal cryptographic key in a non-volatile storage unit.

In order to not generate the internal cryptographic key at every cryptographic key request again, it is possible to store the generated internal cryptographic key in a non-volatile storage unit. This increases the efficiency of the above-described method.

In one embodiment, a non-volatile storage unit is a storage unit that stores its data also even if the non-volatile storage unit is no longer supplied with power or supply voltage. Therefore, a non-volatile storage unit is a storage unit that persistently stores its data. Examples for a non-volatile storage unit are Read only memories (ROM), Flash-storage units, or hard disks.

According to a further embodiment, the trust module is formed as a crypto controller, a hardware security module implemented on a security chip, within a separated execution environment as a Trusted Execution Environment (TEE), or an Intel Software Guard Extension (SGX).

In one embodiment, a security chip is a trusted platform module.

According to a second aspect, a computer program product that includes program code for executing the above-described method according to the first aspect when run on at least one computer is provided.

A computer program product, such as a computer program means, may be embodied as a memory card, USB stick, CD-ROM, DVD, or as a file that may be downloaded from a server in a network. For example, such a file may be provided by transferring the file including the computer program product from a wireless communication network.

According to a third aspect, a trust module for generating a cryptographic key for establishing a secure data communication with a processing device is provided. The trust module includes an input unit configured to receive a cryptographic key request from the processing device, where the cryptographic key request includes a key identifier provided by the processing device, and where the key request is protected by a digital signature of the processing device. The trust module also includes a verification unit configured to verify the digital signature based on a public key assigned to the processing device. The trust module also includes a first key generation unit configured to generate an internal cryptographic key based on the public key assigned to the processing device and a secret key assigned to the trust module. The trust module also includes a second key generation unit configured to generate the cryptographic key based on the internal cryptographic key and the key identifier provided by the processing device. The trust module also includes an encryption unit configured to encrypt the cryptographic key using the public key assigned to the processing device. The trust module also includes an output unit configured to transmit the encrypted cryptographic key to the processing device. The trust module is implemented as a stateless Lambda trust anchor.

The respective unit (e.g., the processing unit) may be implemented in hardware and/or in software. If the unit is implemented in hardware, the unit may be embodied as a device (e.g., as a computer or as a processor or as a part of a system, such as a computer system). If the unit is implemented in software, the unit may be embodied as a computer program product, as a function, as a routine, as a program code, or as an executable object.

According to a further embodiment of the trust module, the trust module further includes a control device or unit implemented to operate the trust module according to the above-described method according to the present embodiments for establishing the secure data communication as described above or below.

According to a further embodiment of the trust module, the trust module is implemented in a cloud backend of a Function-as-a-service-Cloud-Infrastructure (FaaS-infrastructure) and is configured to generate a client-specific key in dependence of a requesting client.

In one embodiment, the trust module in a FaaS-infrastructure is used by other entities that are implemented within the cloud backend. For example, other entities include clients, container, or applications.

Further, for a secured encrypting of data that is assigned to the client, a client-specific key may be generated by the trust module in dependence of the private key or secret key of the client. In one embodiment, the client-specific key is generated in the cloud backend by the trust module “on the fly” and is stored in a volatile storage unit. This has the advantage that no configuration of the client and the trust module for generating the client-specific key is required. This decreases the access authentication configuration effort. Specifically, the client-specific key is used for a secured storage of the data of the client in a cloud (e.g., data at rest).

For example, the trust module that is used in the cloud backend is implemented hardware-based. Compared with cloud-hardware security modules that are implemented in the cloud, for a trust module in the cloud backend, it is not required to administer and configure specific keys at the trust module because the trust module may generate keys “on the fly”. In one embodiment, at applications that are executed within the cloud, a secured, reliable, and simplified protection may be realized by using stateless trust modules.

According to a fourth aspect, a field device or an edge device is provided. The device includes a programmable hardware unit including at least a trust module (e.g., according to the above-described trust module for generating a cryptographic key) and a processing device including at least an application. The field device is configured to establish a secure data communication for the application based on a cryptographic key obtained by a cryptographic key request from the trust module.

In one embodiment, the trust module is implemented in a field device (e.g., in the programmable hardware unit of the field device). The programmable hardware unit may be a FPGA.

The field device may include a System-on-a-chip (Soc). The field device may be a device, an Internet-of-Things-device, an edge device, a cloud edge device, or a device that is arranged within an automation system or an embedded system and includes one or more SoCs on which the trust module is implemented.

The embodiments and features described with reference to the method apply mutatis mutandis to the trust module and field device of the present embodiments.

Further possible implementations or alternative solutions also encompass combinations, which are not explicitly mentioned herein, of features described above or below with regard to the embodiments. The person skilled in the art may also add individual or isolated aspects and features to the most basic form of the present embodiments.

### BRIEF DESCRIPTION OF THE DRAWINGS

FIG. 1 shows a flow chart illustrating acts of a method for establishing a secure data communication for a processing device according to an embodiment;

FIG. 2 shows a block diagram of a trust module for generating a cryptographic key according to an embodiment; and

FIG. 3 shows a block diagram of a field device according to an embodiment including the trust module according to FIG. 2 and a processing device.

### DETAILED DESCRIPTION

In the figures, like reference numerals designate like or functionally equivalent elements, unless otherwise indicated.

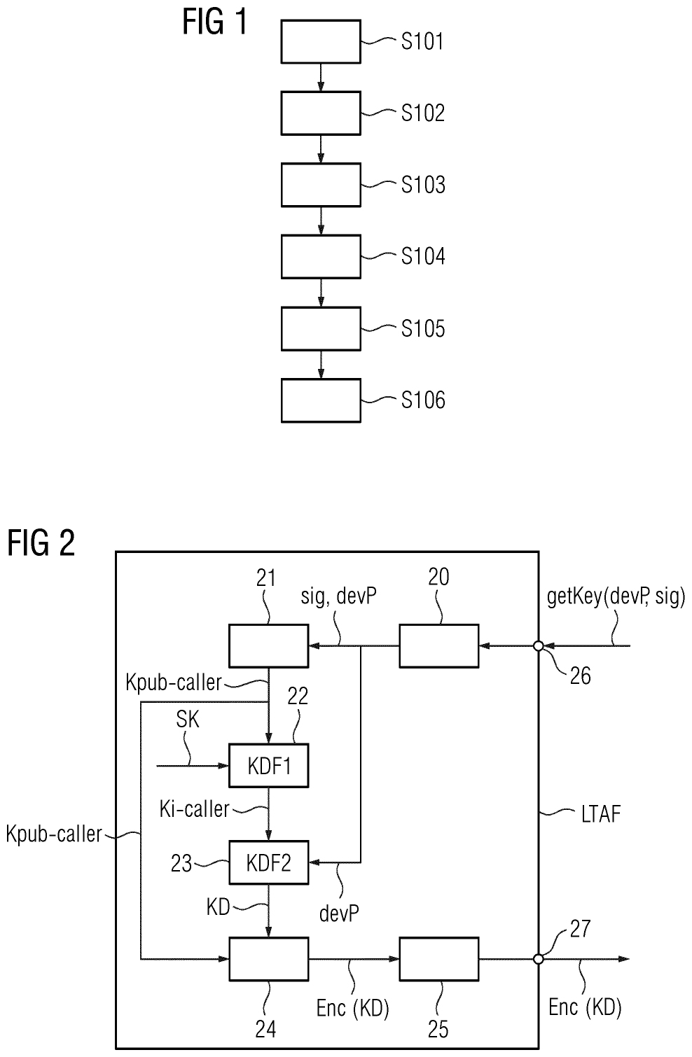

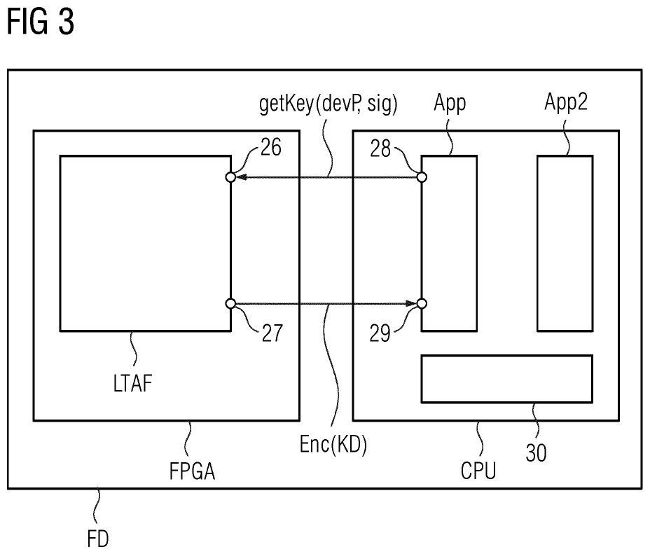

By referring to FIGS. 1, 2, and 3, operation of a trust module LTAF is described. This includes a control process as illustrated in FIG. 1 and a field device FD shown in FIG. 3, in which in a first embodiment, the LTAF is executed.

In FIG. 3, a block diagram of a field device FD according to a first embodiment is shown. The field device FD includes a processing device CPU including an application App, a second application App2, and an operating system 30. Further, the field device FD includes a programmable hardware unit FPGA that includes a stateless trust module LTAF. The field device FD in FIG. 3 is implemented as a System-on-a-chip (SoC).

A cryptographic request getKey is transmitted from the output 28 of the application App to the input 26 of the trust module LTAF if the application App wants to receive a cryptographic key KD from the trust module LTAF. The trust module LTAF is configured to generate the cryptographic key KD in response to the cryptographic request getKey for the application App. The second application App2 is also configured to transmit a cryptographic request getKey to the trust module LTAF. Further, for operating the processing device CPU and the applications App, App2, an operating system 30 is integrated on the processing device 30.

The generated cryptographic key KD is encrypted in order to generate an encrypted cryptographic key Enc(KD). The encrypted cryptographic key Enc(KD) is transmitted from an output 27 of the trust module LTAF to an input 29 of the application App. Then, the application App is configured to decrypt the encrypted cryptographic key Enc(KD). In addition, the application App is configured to establish a secure data communication between the processing device CPU and another device based on the cryptographic key KD received from the trust module LTAF.

FIG. 1 shows a flow chart illustrating acts of a method for establishing a secure data communication for a processing device CPU based on a cryptographic key KD.

Further, the trust module LTAF in FIG. 2 includes the following parts: an input unit 20, a verification unit 21, a first key generation unit 22, a second key generation unit 23, an encryption unit 24, and an output unit 25. The elements cooperatively execute the acts shown in FIG. 1 (e.g., acts S101 to S106).

In FIG. 2, the input unit 20 of the trust module LTAF is configured to receive at an input 26 a cryptographic key request getKey from a processing device CPU, where the cryptographic key request getKey includes a key identifier devP of the processing device CPU and is protected by a digital signature sig of the processing device CPU.

Referring to FIG. 1, in the first act S101, the cryptographic key request getKey is submitted to the trust module LTAF (e.g., to the input 26 of the input unit 20 (see FIG. 2) of the trust module LTAF. In another embodiment, the cryptographic key request getKey is submitted from the processing device CPU to the trust module LTAF via an authenticated communication channel.

Further, in FIG. 2, the verification unit 21 is configured to verify the digital signature sig based on a public key Kpub-caller assigned to the processing device CPU. In this embodiment, the public key Kpub-caller is submitted to the trust module LTAF within the cryptographic key request getKey. In another embodiment, the public key Kpub-caller is submitted to the trust module LTAF as a part of the digital signature sig or as a raw key or by referencing the public key Kpub-caller. Next, the public key Kpub-caller is forwarded to the first key generation unit 22 (see FIG. 2).

Hence, according to act S102, the digital signature sig is verified based on the public key Kpub-caller.

In act S103 in FIG. 1, an internal cryptographic key Ki-caller is generated by the first key generation unit 22 (see FIG. 2) based on the public key Kpub-caller assigned to the processing device CPU and a secret key SK assigned to the trust module LTAF.

In this embodiment, the first key generation unit 22 of FIG. 2 is configured to generate the internal cryptographic key Ki-caller using a first key derivation function KDF1. The first key derivation function KDF1 maps the public key Kpub-caller and the secret key SK to the internal cryptographic key Ki-caller. In another embodiment, the internal cryptographic key Ki-caller is generated using a key generation function at which a public-private key pair is generated based on a primary seed. The generated internal cryptographic key Ki-caller is then forwarded to the second key generation unit 23 shown in FIG. 2.

In this embodiment, the generated internal cryptographic key Ki-caller is stored in non-volatile storage unit. The generated internal cryptographic key Ki-caller may also be stored in a volatile storage unit.

In FIG. 1, in act S104, the cryptographic key KD is generated by the second key generation unit 23 (see FIG. 2) based on the internal cryptographic key Ki-caller and the key identifier devP provided by the processing device CPU. In this embodiment, the second key generation unit 23 of FIG. 2 is configured to generate the cryptographic key KD using the second key derivation function KDF2. The second key derivation function KDF2 maps the internal cryptographic key Ki-caller and the key identifier devP provided by the processing device CPU to the cryptographic key KD. Next, the generated cryptographic key KD is transmitted to the encryption unit 24, which is shown in FIG. 2.

Further, in act S105 of FIG. 1, the cryptographic key KD is encrypted by the encryption unit 24 (see FIG. 2) using the public key Kpub-caller assigned to the processing device CPU and is then forwarded to the output unit 25 of FIG. 2.

The output unit 25 of FIG. 2 is configured to transmit the encrypted cryptographic key Enc(KD) to the processing device CPU (e.g., from the output 27 of the trust module LTAF to the input 29 (see FIG. 3) of the application App that is integrated within the processing unit CPU (see FIG. 3)). This corresponds to act S106 in FIG. 1.

In this embodiment, in a further act, the encrypted cryptographic key Enc(KD) is decrypted using a secret key Kpriv-caller assigned to the processing device CPU.

As a result, a secure data communication between the processing device CPU and another device using the cryptographic key KD obtained and generated from the trust module LTAF is established.

In another embodiment that is not shown, a data structure is decrypted by the secret key SK that is assigned to the trust module LTAF. The data structure is transmitted as a part of the cryptographic key request getKey from the processing device CPU to the trust module LTAF in order to obtain a decrypted key out of the data structure. The decrypted key is used for a cryptographic operation of the trust module LTAF.

The trust module LTAF in FIG. 2 is implemented as a stateless Lambda trust anchor. The trust module LTAF further includes a control device (not shown) that is implemented to operate the trust module LTAF according to the acts S101-S106 of FIG. 1.

In a further embodiment, the trust module LTAF is implemented in a cloud backend of a Function-as-a-service-Cloud-Infrastructure and is configured to generate a client-specific key in dependence of a requesting client.

In a further embodiment, the trust module LTAF is formed as a crypto controller, a hardware security module implemented on a security chip, within a separated execution environment as a Trusted Execution Environment (TEE), or an Intel Software Guard Extension (SGX).

The elements and features recited in the appended claims may be combined in different ways to produce new claims that likewise fall within the scope of the present invention. Thus, whereas the dependent claims appended below depend from only a single independent or dependent claim, it is to be understood that these dependent claims may, alternatively, be made to depend in the alternative from any preceding or following claim, whether independent or dependent. Such new combinations are to be understood as forming a part of the present specification.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. A method for establishing a secure data communication for a processing device based on a cryptographic key, the method comprising:
submitting a cryptographic key request to a trust module, the cryptographic key request including a key identifier provided by the processing device and the cryptographic key request being protected by a digital signature of the processing device;
verifying, at the trust module, the digital signature based on a public key assigned to the processing device;
generating, at the trust module, an internal cryptographic key based on the public key assigned to the processing device and a secret key assigned to the trust module;
generating, at the trust module, the cryptographic key based on the internal cryptographic key and the key identifier provided by the processing device;
encrypting, at the trust module, the cryptographic key using the public key assigned to the processing device; and
transmitting the encrypted cryptographic key to the processing device;
wherein the trust module is implemented as a stateless Lambda trust anchor.

2. The method of claim 1, further comprising:
decrypting, at the processing device, the encrypted cryptographic key using a secret key assigned to the processing device; and
establishing a secure data communication between the processing device and another device using the cryptographic key.

3. The method of claim 1, wherein the public key assigned to the processing device is submitted to the trust module as a part of the digital signature or as a raw key or by referencing the public key.

4. The method of claim 1, further comprising:
generating the internal cryptographic key using a key derivation function,
wherein the key derivation function maps the public key assigned to the processing device and the secret key assigned to the trust module to the internal cryptographic key.

5. The method of claim 1, further comprising:
generating, the internal cryptographic key using a key generation function at which a public-private key pair is generated based on a primary seed.

6. The method of claim 1, further comprising:
generating the cryptographic key using a key derivation function,
wherein the key derivation function maps the internal cryptographic key and the key identifier of the processing device to the cryptographic key.

7. The method of claim 1, further comprising:
decrypting, by the secret key that is assigned to the trust module, a data structure that is transmitted as a part of the cryptographic key request from the processing device to the trust module, such that a decrypted key is obtained out of the data structure,
wherein the decrypted key is used for a cryptographic operation of the trust module.

8. The method of claim 1, further comprising:
submitting, the cryptographic key request from the processing device to the trust module via an authenticated communication channel.

9. The method of claim 1, further comprising:
storing the generated internal cryptographic key in a volatile storage unit.

10. The method of claim 1, further comprising:
storing the generated internal cryptographic key in a non-volatile storage unit.

11. The method of claim 1, wherein the trust module is formed as a crypto controller, as a hardware security module implemented on a security chip, within a separated execution environment as a Trusted Execution Environment, or as an Intel Software Guard Extension.

12. In a non-transitory computer-readable storage medium that stores instructions executable by at least one computer to establish a secure data communication for a processing device based on a cryptographic key, the instructions comprising:
submitting a cryptographic key request to a trust module, the cryptographic key request including a key identifier provided by the processing device and the cryptographic key request being protected by a digital signature of the processing device;
verifying, at the trust module, the digital signature based on a public key assigned to the processing device;
generating, at the trust module, an internal cryptographic key based on the public key assigned to the processing device and a secret key assigned to the trust module;
generating, at the trust module, the cryptographic key based on the internal cryptographic key and the key identifier provided by the processing device;
encrypting, at the trust module, the cryptographic key using the public key assigned to the processing device; and
transmitting the encrypted cryptographic key to the processing device,
wherein the trust module is implemented as a stateless Lambda trust anchor.

13. A trust module for generating a cryptographic key for establishing a secure data communication with a processing device, the trust module comprising:
an input unit configured to receive a cryptographic key request from the processing device, wherein the cryptographic key request includes a key identifier provided by the processing device, and wherein the cryptographic key request is protected by a digital signature of the processing device;
a verification unit configured to verify the digital signature based on a public key assigned to the processing device;
a first key generation unit configured to generate an internal cryptographic key based on the public key assigned to the processing device and a secret key assigned to the trust module;
a second key generation unit configured to generate the cryptographic key based on the internal cryptographic key and the key identifier provided by the processing device;
an encryption unit configured to encrypt the cryptographic key using the public key assigned to the processing device; and
an output unit configured to transmit the encrypted cryptographic key to the processing device,
wherein the trust module is implemented as a stateless Lambda trust anchor.

14. The trust module of claim 13, further comprising a control device configured to:
decrypt the encrypted cryptographic key using a secret key assigned to the processing device; and
establish a secure data communication between the processing device and another device using the cryptographic key.

15. The trust module of claim 13, wherein the trust module is implemented in a cloud backend of a Function-as-a-service-Cloud-Infrastructure and is configured to generate a client-specific key in dependence of a requesting client.

16. A field device comprising:
a programmable hardware unit comprising a trust module for generating a cryptographic key for establishing a secure data communication with a processing device, the trust module comprising:
an input unit configured to receive a cryptographic key request from the processing device, wherein the cryptographic key request includes a key identifier provided by the processing device, and wherein the cryptographic key request is protected by a digital signature of the processing device;
a verification unit configured to verify the digital signature based on a public key assigned to the processing device;
a first key generation unit configured to generate an internal cryptographic key based on the public key assigned to the processing device and a secret key assigned to the trust module;
a second key generation unit configured to generate the cryptographic key based on the internal cryptographic key and the key identifier provided by the processing device;
an encryption unit configured to encrypt the cryptographic key using the public key assigned to the processing device; and
an output unit configured to transmit the encrypted cryptographic key to the processing device, wherein the trust module is implemented as a stateless Lambda trust anchor; and
the processing device comprising at least an application,
wherein the field device is configured to establish a secure data communication for the application based on a cryptographic key obtained by a cryptographic key request from the trust module.
